(19) United States
(12) Patent Application Publication
(10) Pub. No.: US 2021/0339364 A1
(43) Pub. Date: Nov. 4, 2021

(54) TORQUE SCREWDRIVER

(71) Applicant: YIH CHENG FACTORY CO., LTD., Nantuo (TW)

(72) Inventor: Jack LIN, Nantuo (TW)

(21) Appl. No.: 16/864,135

(22) Filed: Apr. 30, 2020

(51) Int. Cl. B25B 23/142

(52) U.S. Cl. CPC B25B 23/1427; B25B 15/02

(57) ABSTRACT

A torque screwdriver includes a sleeve (10), an escape element (20), an elastic body (30) and a shaft (40). The sleeve (10) has a first trough (11), a second trough (12) and a third trough (13). The escape element (20) is disposed in the third trough (13) and rotated with the sleeve (10). The sleeve (10) has driving teeth (22). Each driving tooth (22) has a buffer surface (222). The elastic body (30) is disposed in the sleeve (10) and formed beside the escape element (20). The shaft (40) includes a teeth seat (41) and a rod (43). The teeth seat (41) is disposed in the third trough (13) and has driven teeth (411). Each driven tooth (411) engages or disengages with one of the driving teeth (22). Thereby, the structural strength of each driving tooth can be enhanced to increase durability, and the operational feel also becomes better.

### BACKGROUND OF THE INVENTION

### Technical Field

The invention relates to screwdrivers, particularly to torque screwdrivers.

### Related Art

Tightening and loosening of a screw must be implemented by a screwdriver. Proper use requires that the screwdriver's tip, which is shaped to fit the driving surfaces, engages the head of a screw of the same size and type designation as the screwdriver tip. The screw engaged with the tip can be tightened or loosened by clockwise or counterclockwise rotating the screwdriver.

A conventional screwdriver undetachably or detachably connects a handle to a shaft to form a whole body. However, the torque generated by both the handle and the shaft is still invariable. Screws applied in different places need different torque values. Torque generated by such a screwdriver can be changed only by a user's feel, so precision torque applied to a screw is unavailable. Also, a ratchet screwdriver can increase its torque, but the torque is still invariable, so it has the same problem.

To solve the above problem, a torque screwdriver appears in the market. However, its transmission teeth are usually too sharp, so not only are the teeth easy to be cracked or broken, but also its operating feel is not good because of unsmoothness caused by its sharp engagement of the teeth.

In view of this, the inventor has devoted himself to the above-mentioned prior art, researched intensively and cooperated with the application of science to try to solve the above-mentioned problems, which has become the goal of the inventor's improvement.

### SUMMARY OF THE INVENTION

An object of the invention is to provide a torque screwdriver, which can improve the structural strength of the transmission teeth to increase durability and to make the operating feel better.

To accomplish the above object, the invention provides a torque screwdriver, which includes a sleeve, an escape element, an elastic body and a shaft. The sleeve has a first trough, a second trough and a third trough. The escape element is disposed in the third trough and rotated with the sleeve. The sleeve has driving teeth. Each driving tooth has a buffer surface. The elastic body is disposed in the sleeve and formed beside the escape element. The shaft includes a teeth seat and a rod. The teeth seat is disposed in the third trough and has driven teeth. Each driven tooth engages or disengages with one of the driving teeth.

The invention further has the following functions. By the buffering and smoothing effect formed by the buffer surfaces of the driving teeth and the driven teeth, the operating feel becomes better and the structural strength of the teeth becomes higher. By the different sizes of the troughs, all components can be assembled in order, so the assembling becomes easier. The elastic body held between the fixing plate and the escape element can stably control the torque. The adjusting ring can adjust a required torque.

### BRIEF DESCRIPTION OF THE DRAWINGS

FIG. 1 is an exploded view of the torque screwdriver of the invention;

FIG. 2 is a perspective view of the escape element and the shaft of the torque screwdriver of the invention;

FIG. 3 is a schematic view of the torque screwdriver of the invention;

FIG. 4 is another schematic view of the torque screwdriver of the invention;

FIG. 5 is a cross-section view of the torque screwdriver of the invention;

FIG. 6 is another cross-section view of the torque screwdriver of the invention;

FIG. 7 is a cross-section view of the torque screwdriver of the invention in use; and

FIG. 8 is another cross-section view of the torque screwdriver of the invention in use.

### DETAILED DESCRIPTION OF THE INVENTION

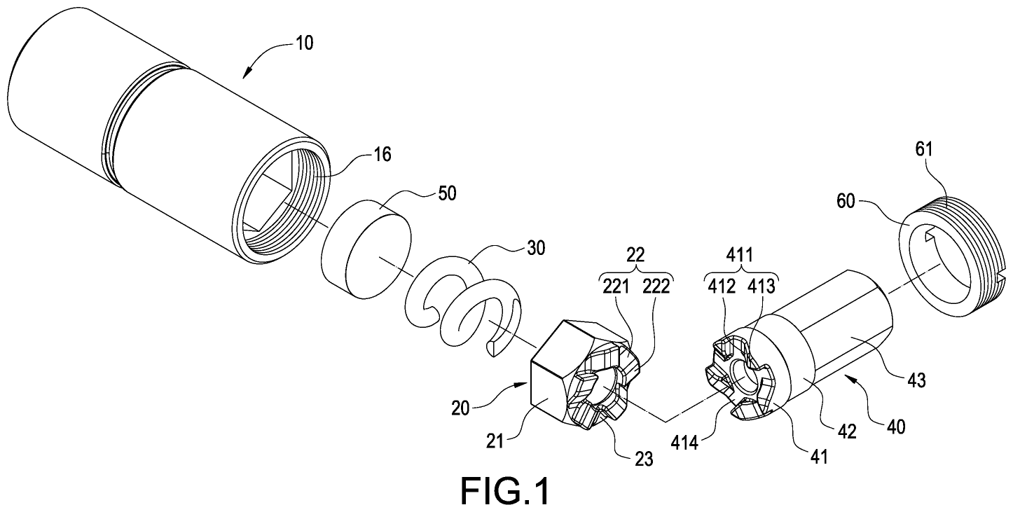

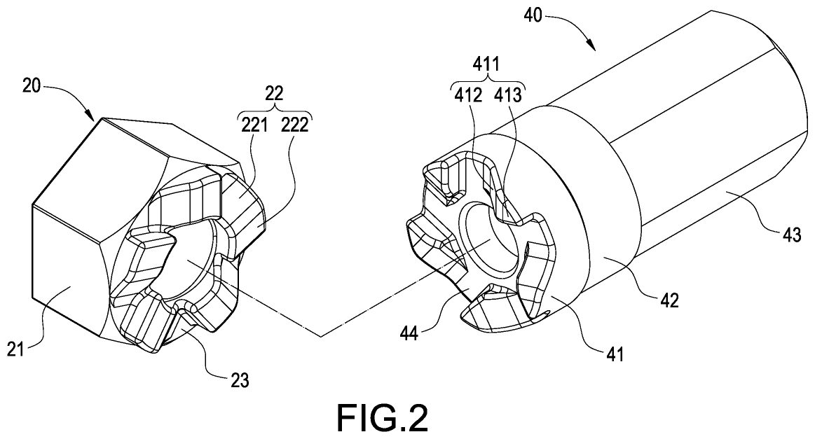

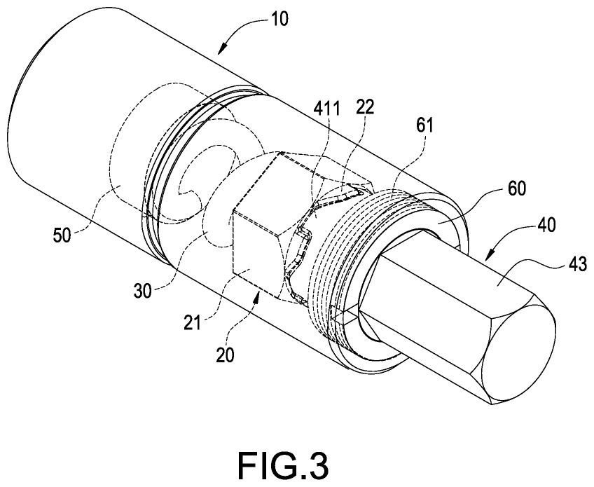

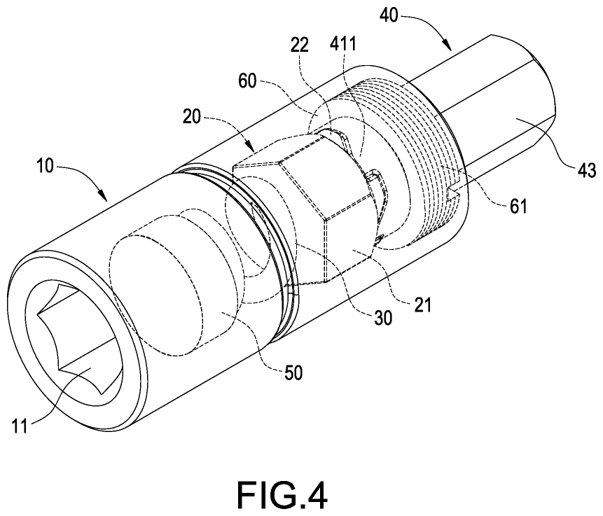

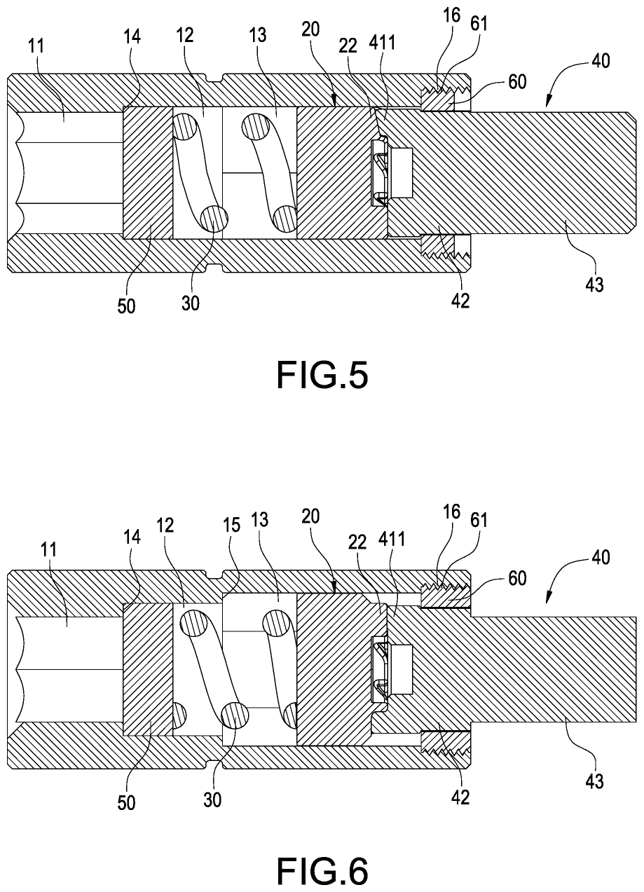

Please refer to FIGS. 1-6. The invention provides a torque screwdriver, which includes a sleeve 10, an escape element 20, an elastic body 30 and a shaft 40.

The sleeve 10 may be a round hollow cylinder and has a first trough 11, a second trough 12 and a third trough 13. The second trough 12 is formed at a middle section of the sleeve 10. The first trough 11 and the third trough 13 are separately formed at two opposite sides of the second trough 12. Each of the first trough 11 and the third trough 13 is of a regular hexagonal shape, so that each side thereof forms a positioning function. The second trough 12 is of a circular shape. A peripheral size of the first trough 11 is less than an inner diameter of the second trough 12. An inner diameter of the second trough 12 is less than a peripheral size of the third trough 13. A first step 14 is formed at a junction between the first trough 11 and the second trough 12. A second step 15 is formed at another junction between the second trough 12 and the third trough 13. Further, an inner thread 16 is disposed at an end of the third trough 13, which is away from the second trough 12.

The escape element 20 is disposed in the third trough 13 and includes a base plate 21 and driving teeth 22 extending from an end of the base plate 21. The base plate 21 is a regular hexagonal plate which can be embedded into the third trough 13 so that it can be rotated with the sleeve 10. Each driving tooth 22 has a slant 221 and a buffer surface 222 connected to an end of the slant 221. A notch 23 is formed between each adjacent two of the driving teeth 22. The driving teeth 22 and the notches 23 jointly form a circle.

In the exemplary embodiment, the elastic body 30 is a torque spring and disposed between the second trough 12 and the third trough 13 and beside the base plate 21 of the escape element 20.

The shaft 40 includes a teeth seat 41, a cylinder section 42 and a rod 43. The cylinder section 42 extends from an end surface of the teeth seat 41. The teeth seat 41 is disposed in the third trough 13 and has driven teeth 411. Each driven tooth 411 includes a slant 412 and a buffer surface 413 connected with an end of the slant 412. A notch 414 is formed between each adjacent two of the driven teeth 411. The driven teeth 412 and the notches 414 jointly form a circle. Each driven tooth 411 engages or disengages with one of the driving teeth 22. The rod 43 extends from an end of the cylinder section 42, which is away from the teeth seat 41. The rod 43 has a regular hexagonal cross-section and projects from the sleeve 10.

The torque screwdriver of the invention further includes a fixing plate 50 disposed in the second trough 12 and abutting against the first step 14. The fixing plate 50 may be made of a magnetic material.

The torque screwdriver of the invention further includes an adjusting ring 60 disposed in the third trough 13 and away from the second step 15. The adjusting ring 60 has an outer thread 61 and is put around the cylinder section 42. By the screwing between the outer thread 61 and the inner thread 16, both compression and torque of the elastic body 30 can be controlled.

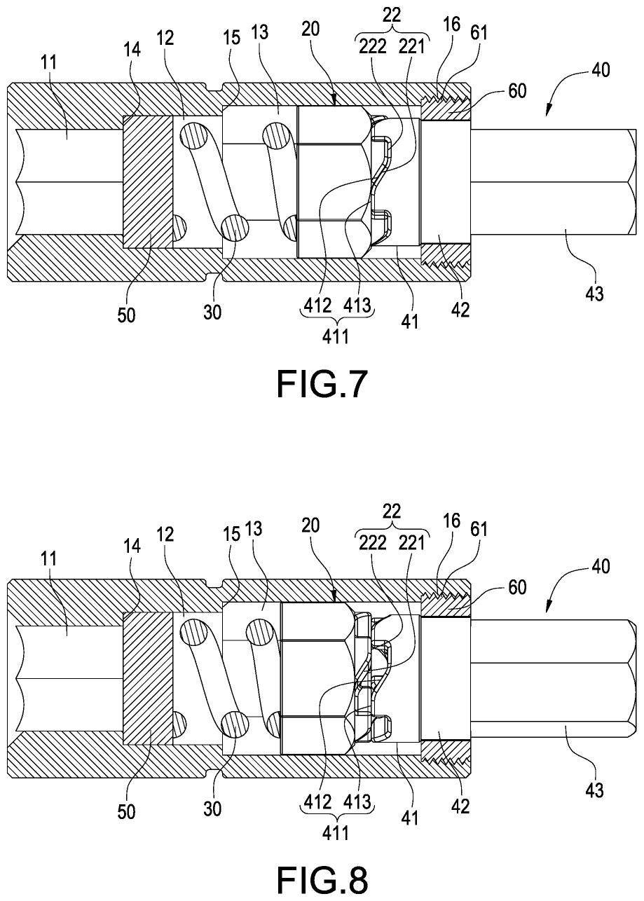

Please refer to FIGS. 7 and 8. When rotating the sleeve 10, the escape element 20 is rotated synchronously. A user can rotate a screw by engaging the driving teeth 22 and the driven teeth 411. When the rotating torque is greater than the torque predetermined by the elastic body 30, the shaft 40 is fixed, and escape element 20 is elevated by the slants 221 of the driving teeth 22 along the slants 412 of the driven teeth 411. Also, by the buffering and smoothing effect formed by the buffer surfaces 222 of the driving teeth 22 and the buffer surfaces 413 of the driven teeth 411, the operating feel becomes better.

It will be appreciated by persons skilled in the art that the above embodiments have been described by way of example only and not in any limitative sense, and that various alterations and modifications are possible without departure from the scope of the invention as defined by the appended claims.

What is claimed is:

1. A torque screwdriver comprising:
a sleeve (10), having a first trough (11), a second trough (12) formed beside the first trough (11) and a third trough (13) formed beside the second trough (12);
an escape element (20), disposed in the third trough (13), rotated with the sleeve (10), comprising driving teeth (22), and each driving tooth (22) having a buffer surface (222);
an elastic body (30), disposed in the sleeve (10) and formed beside the escape element (20); and
a shaft (40), comprising a teeth seat (41) and a rod (43) extended from the teeth seat (41), the teeth seat (41) being disposed in the third trough (13) and having driven teeth (411), each driven tooth (411) engaging or disengaging with one of the driving teeth (22).

2. The torque screwdriver of claim 1, wherein each driving tooth (22) further comprises a slant (221) connected to the buffer surface (222), and a notch (23) is formed between each adjacent two of the driving teeth (22).

3. The torque screwdriver of claim 1, wherein each driven tooth (411) further comprises a slant (412) and a buffer surface (413) connected to an end of the slant (412), and a notch (414) is formed between each adjacent two of the driven teeth (411).

4. The torque screwdriver of claim 1, further comprising a fixing plate (50), wherein a first step (14) is formed at a junction between the first trough (11) and the second trough (12), the fixing plate (50) is disposed in the second trough (12) and abutting against the first step (14), and the elastic body (30) is held between the fixing plate (50) and the escape element (20).

5. The torque screwdriver of claim 4, wherein the elastic body (30) is a torque spring, and the fixing plate (50) is a magnetic element.

6. The torque screwdriver of claim 1, further comprising an adjusting ring (60) disposed in the third trough (13) and away from the second trough (12).

7. The torque screwdriver of claim 6, wherein the adjusting ring (60) has an outer thread (61), and the third trough (13) is formed with an inner thread (16) screwed with the outer thread (61).

8. The torque screwdriver of claim 6, wherein the shaft (40) further comprises a cylinder section (42) between the teeth seat (41) and the rod (43), and the adjusting ring (60) is put around the cylinder section (42).

9. The torque screwdriver of claim 1, wherein each of the first trough (11) and the third trough (13) is of a regular hexagonal shape, the second trough (12) is of a circular shape, a peripheral size of the first trough (11) is less than an inner diameter of the second trough (12), and an inner diameter of the second trough (12) is less than a peripheral size of the third trough (13).

10. The torque screwdriver of claim 9, wherein the escape element (20) comprises a base plate (21), the driving teeth (22) extend from an end of the base plate (21), and the base plate (21) corresponds to the third trough (13) in shape so that the escape element (20) can be rotated with the sleeve (10).
